(19) United States
(12) Patent Application Publication
(10) Pub. No.: US 2010/0202869 A1
(43) Pub. Date: Aug. 12, 2010

(54) HUBLESS WINDMILL

(75) Inventors: Sridhar Condoor, Fenton, MO (US); Khoa D. Nguyen, St. Louis, MO (US); Michael Reichle, St. Louis, MO (US)

Correspondence Address: HUSCH BLACKWELL SANDERS LLP, 190 Carondelet Plaza, Suite 600, ST. LOUIS, MO, 63105, US

(73) Assignee: SAINT LOUIS UNIVERSITY, St. Louis, MO (US)

(21) Appl. No.: 12/530,454

(22) PCT Filed: Mar. 6, 2008
(86) PCT No.: PCT/US08/56105

§ 371 Date: Apr. 1, 2010

(30) Foreign Application Priority Data
Mar. 6, 2007 (US) 60893311

(51) Int. Cl. F01D 15/12; F03B 3/12

(52) U.S. Cl. 415/1; 416/235; 415/122.1

(57) ABSTRACT

Systems, apparatus and methods for generating power from fluid motion, such as wind are provided. The apparatus is a wing-shaped airfoil with cup-shaped indentations that allow the airfoil to harness wind energy throughout a wide range of wind speeds and from different wind directions. The indentations harness wind energy at low wind speeds while the wing-shape generates a lifting force at high wind speeds to harness wind energy. The system comprises one or more of the devices configured in a hollow, generally cylindrical, shape and connected to a ring frame. The system rotates about an axis running through the center of the ring frame. The rotational motion of the system generates electrical power via a generator. The method is a method for generating electrical power from the rotational motion of the system.

### CROSS-REFERENCE TO RELATED APPLICATIONS

This application claims priority to co-pending U.S. Provisional Patent Application Ser. No. 60/893,311, filed Mar. 6, 2007, the entire disclosure of which is incorporated herein by reference.

### FIELD OF THE INVENTION

This invention relates to systems, apparatus and methods for generating power from fluid motion in general, and specifically for generating power from wind.

### BACKGROUND OF THE INVENTION

The idea of harnessing wind for power has been around for millennia, from the simple sail to sophisticated windmills. Most of the harvesting of wind energy takes place far away from the areas in need of power. Therefore, it would be beneficial to provide a way to harvest wind energy in locations such as cities and industrial centers.

Traditional “tower” windmills are well-known in the art. Windmills extract power from a wind current by use of blades mounted to a centralized rotatable structure (hub) to turn a shaft. The mass of a wind current impinging upon the blade, and flowing around it, transmits a force to the blade which is transformed into a torque about the drive shaft on which the blades rotate to power pumps, generators, compressors, or the like. Similar principles may be employed to extract power from any fluid flow, including wind current.

Various designs have been conceived for windmills. Some have used propeller-like blades connected to a hub which rotates on a horizontal shaft directed generally parallel to the wind flow. Machines of this type are commonly found on farms to power pumps, or the like, at remote locations. It is necessary to orient the orbiting blades perpendicular to the direction of the wind for this type of windmill, in order to properly expose them to the wind current so they will generate a rotational force. This directional sensitivity reduces the efficiency of these type of windmills in any area having unstable gusting wind currents. It also requires that a steering mechanism be used to position the blades. Further, in recent years, structural difficulties have been found in making these machines of a sufficiently large size to produce the power necessary to meet current needs, especially for electricity generation. These difficulties arise not only from the type and height of a structure necessary to position the blades in an adequate wind flow, but also from the high centrifugal forces to which the rotating blades are subjected.

Other designs have a number of blades circularly mounted about a rotatable structure in carousel fashion. The structure includes a shaft positioned with its axis generally parallel to the axis of the blades, and perpendicularly positioned with the wind flow. These type of machines, commonly referred to as cross-wind axis wind turbines, are usually installed with the blades and shaft positioned vertically with the ground surface. In this configuration the blade surfaces are exposed to wind currents blowing from any direction, making them capable of capturing energy with instantaneous response from directionally changing winds, without need of a steering device sensitive to wind direction. Further, due to the vertical position of the rotating shaft it is unnecessary to mount a driven implement or a right angle drive, such as a gear box, at a high elevation on the supporting structure of the windmill.

A blade of a wind machine obtains power from the wind by slowing the free stream wind speed downstream of the blade. In the design of windmills, or wind turbines, two principle motive forces can be generated from this wind speed change to provide torque about the rotating shaft. The first is a drag force acting on the blades which is caused by the wind current impinging on the surface of the blade. The drag force is created by the transfer of kinetic energy of the moving wind mass to the blade as the wind current is slowed by contacts with the surface of the blade as the wind flows around its form. Drag-type wind machines are self-starting and generally produce high torque from their starting mode through low rotational speeds.

A drag-type wind machine, however, has inherent limitations. The tip speed of the rotating blade cannot be faster than the speed of the wind and usually it is somewhat less. This characteristic limits the rotational velocity of the shaft to which the blades are affixed, and it may require a transmission to obtain the shaft speed required for performing the desired work.

The ratio of the blade tip speed to the wind speed is commonly known as the tip speed ratio. This value is used as a measure of the functional range of efficient operation of the wind machine. Generally, a drag-type machine will produce optimum power when the tip speed of its blades approaches that of the free stream wind speed, meaning the tip speed ratio is close to one. However, a limit of the maximum tip speed attainable is also a limit to the amount of power which can be produced. A drag-type wind machine, being limited to a maximum ideal tip speed ratio of one, is thereby limited in its capability to produce power and in its efficiency. The maximum efficiency obtainable with the drag-type wind machine is a moderate value of about 30%, usually something less.

The second motive force employed to propel a wind machine is a lift force generated as wind current flows past an airfoil. This type of wind machine uses a blade formed in the shape of an airfoil positioned so that the lift forces generated by the wind current flowing over the blade will act in a direction to move the blade in its orbit. A component of the lift force in the direction of rotation is applied through a rotor structure to the rotating shaft to create a torque about the shaft.

Lift-type wind turbines are known to have blade velocities much higher than that of the free-stream wind speed. They therefore have tip speed ratios in excess of one, and often in the range of four to six. This is because blade speed is not directly dependent on a wind velocity component, but rather on a lift force component. Generally, the higher the tip speed ratio the more efficient the operation of the wind machine to produce power. The very high rotational speeds of lift-type wind machines adapt them for use with accessories that require high speeds, such as generators. The high rotational speeds also provide for a higher degree of efficiency and greater power production.

Generally, lift-type machine efficiencies are found in a range of 35 to 45%. Tip speed ratios may range from less than 1, as is common for the typical farm-type windmill, to between 4 and 6, as is common for vertical axis-type wind turbines as described in U.S. Pat. No. 1,835,018 to G. J. M. Darrieus (the entire disclosure of which is incorporated herein by reference).

The tip speed ratio is a critcal parameter of the lift-type machine, especially the Darrieus type wind turbines. Because a value curve of efficiency versus tip speed ratio for this type machine is highly peaked, a small change in the wind speed can result in a large change in efficiency, and a resultant loss of available power. This effect can be so severe as to cause the rotor to stop turning altogether. This so-called stall of the wind turbine may result from changes in the tip speed ratio due to wind gusts, i.e. an increase in wind velocity, as well as changes in the tip speed ratio from wind stagnation. Surmounting this characteristic normally requires a control system to vary the load placed on the turbine, or to vary the blade pitch angles more directly toward their relative wind flow, to prevent the machine from completely stopping.

Additionally, because of their narrow range of efficient operation, some common lift-type wind machine designs will not self-start, requiring a power input to the driven shaft to initiate rotation and bring the speed of the turbine up to a tip speed ratio of self-sufficient operation. This inability to begin rotation and accelerate to an efficient rotational speed is severe with the Darrieus lift-type (crosswind axis) wind turbine. It has given rise to auxiliary methods for self-starting which include the addition of external power sources apart from wind energy and the addition of drag-type blade forms mounted with the lift-type blades to the rotor structure to initiate rotation, as is described in the Bolie U.S. Pat. No. 4,204,805 (the entire disclosure of which is incorporated herein by reference).

An increasingly common method of self-starting a Darrieus type wind turbine is the use of variable pitch blades on the rotor which are articulated to change their pitch angle with reference to the relative wind current as they travel around their carousel-shaped path. Blade articulation increases the total efficiency of the wind turbine by providing maximized lift force on the blades for a greater period throughout their orbital cycle. The blades are typically hinged on their longitudinal axis parallel to the axis of the driven rotating shaft so that they may be pivoted.

Past designs have succeeded in providing a self-starting capability for lift-type wind turbines. They have further been able to provide articulating blade features which enhance efficiency and power at a specific turbine rotational speed, and which can limit the turbines maximum rotational speed to prevent damage from centrifugal forces in an over-speed condition. Some even describe a wind turbine, that is capable of self-starting, that is somewhat more efficient throughout its entire operational speed range, such as U.S. Pat. No. 4,430,044 to Liljegren (the entire disclosure of which is incorporated herein by reference). What is needed is a windmill design that is capable of self-starting, that is efficient throughout a wide range of wind speeds (including low wind speeds), and that can be easily incorporated into new and existing city structures so as to reduce the distance from energy production to energy users. Also what is needed is a windmill design where torsional vibrations are minimized, that can be installed at a relatively low cost, and in such a way as to avoid problems associated with the boundary layer close to the earth surface.

### SUMMARY OF THE INVENTION

An object of the instant invention is to provide apparatus, systems and/or methods for converting wind energy into electricity. One skilled in the art will readily recognize that the invention may be applied in any environment experiencing fluid motion. The fluid may be air, water, or any other substance that experiences properties of fluid motion. For convenience, and not by way of limitation, fluid motion is referred to as “wind” throughout the Specification and Claims. Another object of the instant invention is to provide apparatus that can harness power from wind flowing in any direction. Another object of the instant invention is to provide apparatus that can harness power from wind flowing within a wide range of wind speeds, including low wind speeds. Another object of the instant invention is to provide a system for converting energy from fluid motion into rotational motion. Another object of the instant invention is to provide a windmill system that is capable of self-starting, that is efficient throughout a wide range of wind speeds (including low wind speeds), and/or that can be easily incorporated into new and existing city structures so as to reduce the distance from energy production to energy users. Another object of the instant invention is to provide a windmill design where torsional vibrations are minimized, that can be installed at a relatively low cost, and/or in such a way as to avoid problems associated with the boundary layer close to the earth surface. Another object of the instant invention is to provide a method for generating power by converting wind current to rotational motion to electrical power.

Objects of the instant invention are accomplished through the use of an airfoil capable of producing lift when wind current flows across it in a first direction, and at a high wind speed. The airfoil includes top and bottom cup-shaped indentations that catch the wind, generating momentum, when the wind current flows in a second direction, and at low wind speeds. In one embodiment, the first and second wind flow directions are opposite each other. In another embodiment, the indentation on top is out of phase with the indentation on the bottom. In another embodiment, the indentation on top is aligned with the indentation on bottom. In one preferred embodiment, the airfoil harnesses power from wind flowing in a first direction when the air is flowing within a first range of speeds, by producing lift. In another preferred embodiment, the airfoil harnesses power from wind flowing in a second direction when the air is flowing within a second range of speeds, by catching the wind in the cup-shaped indentations.

Other objects of the instant invention are accomplished through the use of a system for converting energy from fluid motion to rotational motion. The system includes at least one airfoil capable of generating lift connected to a ring frame at the proximal end of the airfoil and connected to a ring gear at the distal end. The system rotates about an axis running through the centers of the ring gear and ring frame. In one embodiment, the axis of rotation is parallel to an imaginary line extending from the distal end to the proximal end of the airfoil. In a preferred embodiment, the ring gear is in rotational communication with a gear that connects to a generator via a shaft. In another embodiment, the airfoil of the system produces lift when wind current flows across it in a first direction and includes cup-shaped indentations that catch the wind, generating momentum, when the wind current flows in the opposite direction. In one preferred embodiment, the system comprises four airfoils, equally spaced from each other, such that the system is generally cylindrical shaped with the interior of the cylindrical shape being empty or otherwise unrelated to the system (i.e., hubless). In other embodiments, the airfoils are not exactly parallel to the rotational axis, but the center of the system is nonetheless empty or otherwise unrelated to the system (hubless). In one preferred embodiment, the airfoils are generally tapered in shape with one end fatter and/or of greater radius from the axis of rotation than the other end. In another preferred embodiment, the airfoils are generally curved shape such that the middle is of greater or lesser radius from the axis of rotation than one or both of the ends of the airfoil.

In other preferred embodiments, two or more systems of the instant invention may be arranged such that structural resistive torques are reduced. In some preferred embodiments, two systems as shown in FIG. 4 are arranged such that they rotate in different directions. In some preferred embodiments, two systems, one as shown in FIG. 4 and the other a mirror image of the system shown in FIG. 4, are arranged such that they share the same axis of rotation, but they rotate in opposite directions. In other preferred embodiments, a system as shown in FIG. 4 and a mirror image of the system of FIG. 4 are arranged such that they rotate in opposite directions and their axes of rotation are parallel, but not identical.

Other objects of the instant invention are achieved through the placement of the system or systems described herein. In some embodiments, the system is located between two floors of a single building or between two different buildings to capitalize on the tunnel effect of wind. In another embodiment, two systems rotate in different or opposite directions. In one embodiment, the center of the cylindrical shaped system is an empty space. In another embodiment, the center of the cylindrical shaped system is unrelated usable space, such as for example a smoke stack, communications antenna, or skywalk. In some preferred embodiments, the axis of rotation is vertical. In other preferred embodiments, the axis of rotation is horizontal. In other embodiments, the airfoils are not exactly parallel to the rotational axis, but the center of the system is nonetheless empty or otherwise unrelated to the system. In some preferred embodiments, the system is mounted to new or existing, unrelated structures with rotational bearings. In other embodiments, the system includes a hub in the center of the ring frame(s) and/or ring gear with support spokes extending from the hub to the ring frame and/or ring gear. One skilled in the art will readily recognize that the system may be mounted to a support structure by a number of means.

Other objects of the instant invention are accomplished through the use of a method for generating power. In one embodiment, the method includes connecting the proximal end of an airfoil to a ring gear and rotating the ring gear and airfoil about an axis that extends through the center of the ring gear. The ring gear is in rotational communication with a gear that is operably connected to a generator via a shaft. In one embodiment, the airfoil produces lift when wind current flows across it in a first direction and includes cup-shaped indentations that catch the wind, generating momentum, when the wind current flows in the opposite direction. In another embodiment, the method includes connecting the distal end of the airfoil to a ring frame such that the shape of the airfoil, ring frame and ring gear is generally cylindrical. Within one (lower) range of wind speeds, the cup-shaped indentations capture the power from the air and set the system in rotational motion. At and above a threshold (higher) wind speed, the wing-shape of the airfoil generates a “lift” force and begins to harness power from the wind more effectively and efficiently than the indentations. Because the motion of the system is rotational, the system continues to turn in the same direction, despite transitioning from converting power using the indentations (from wind flowing in the first direction) to converting power using the lift from the wing shape (from wind flowing in the opposite direction).

The concept of a hubless windmill is especially appealing for skyscrapers with significant energy demands because it generates electricity without taking any ground space. The invention can be placed around skywalks and bridges where the natural wind speeds are high due to the tunnel effect. Also, it will add uniqueness and aesthetics to both buildings and the city skyline. Real-estate companies can capitalize on the green-image and charge higher rates for offices. Industrial applications include power plants that invest in the windmills for their smokestacks. Power plants can increase their net power generating capacity, and reduce their green house gas emission per unit generated, while using green energy partially subsidized by the state. The invention poses minimal additional structural and real-estate needs. Hubless windmills can revolutionize the use of wind power in everyday life by bringing windmills from fields to cities.

The foregoing and other objects are intended to be illustrative of the invention and are not meant in a limiting sense. Many possible embodiments of the invention may be made and will be readily evident upon a study of the following specification and accompanying drawings comprising a part thereof. Various features and subcombinations of invention may be employed without reference to other features and subcombinations. Other objects and advantages of this invention will become apparent from the following description taken in connection with the accompanying drawings, wherein is set forth by way of illustration and example, an embodiment of this invention and various features thereof.

### BRIEF DESCRIPTION OF THE DRAWINGS

A preferred embodiment of the invention, illustrative of the best mode in which the applicant has contemplated applying the principles, is set forth in the following description and is shown in the drawings and is particularly and distinctly pointed out and set forth in the appended claims.

FIG. 1 shows top, bottom and cross-sectional views of an embodiment of an airfoil of the instant invention.

FIG. 2 shows top, bottom and cross-sectional views of another embodiment of an airfoil of the instant invention.

FIG. 3 shows a perspective view of an embodiment of a system of the instant invention

FIG. 4 shows a perspective view of another embodiment of a system of the instant invention

FIG. 5 shows a perspective view of still another embodiment of a system of the instant invention.

### DETAILED DESCRIPTION OF A PREFERRED EMBODIMENT

As required, a detailed embodiment of the present invention is disclosed herein; however, it is to be understood that the disclosed embodiment is merely exemplary of the principles of the invention, which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure.

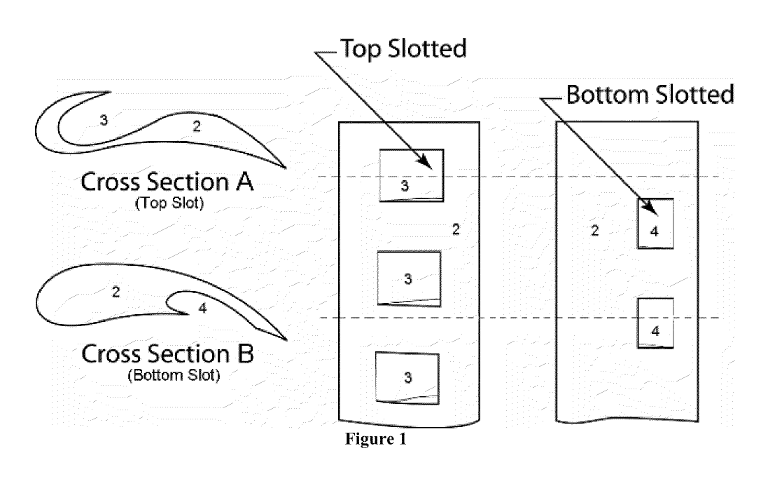

Referring to FIG. 1, an embodiment of an airfoil of the instant invention is shown. FIG. 1 shows a novel wing-shaped aerodynamic body or airfoil apparatus (2). The airfoil (2) includes a general cross-sectional shape much like that of a traditional wing or airfoil in which the leading edge is generally rounded or wider in cross-section and the trailing edge is generally sharp or narrower in cross-section. This wing-shape allows the device to convert energy from wind when the wind is flowing in a direction across the airfoil from the leading edge to the trailing edge, within a certain range of relatively higher wind speeds. Within this higher range of wind speeds, the wing-shape of the device generates a lifting motion on the airfoil.

The airfoil of FIG. 1 is not of uniform cross-section across the length of the airfoil (as viewed from the top or bottom of the airfoil). FIG. 1 depicts several cup-shaped indentations along both the top (3) and bottom (4) of the airfoil. When wind flows in a direction across the airfoil from the trailing edge to the leading edge, within a certain second range of wind speeds, generally lower wind speeds, the air enters the cup-shaped indentations ((3) and (4)) and stagnates, causing drag to push the airfoil (2) forward. The top slots (3) and bottom slots (4) convert wind energy to forward velocity at any wind speed above 0 mph.

FIG. 1 also shows the cross section of the airfoil at two different locations along the length of the airfoil. In the embodiment shown in FIG. 1 the top indentations (3) are not aligned with the bottom indentations (4), as can be seen in the cross section drawings (A) and (B). The cross sections also show the generally wing-like shape, as well as the top (3) and bottom (4) slots of the airfoil.

The device as shown in FIG. 1 is merely one preferred embodiment of the airfoil of the instant invention. In FIG. 1, the device has three top slots (3) and two bottom slots (4). It will be appreciated that alternatives in size or shape of the airfoil (2), and/or size, shape, or number of top slots (3) or bottom slots (4) to those shown in FIG. 1 may be utilized without departing from the spirit and scope of the instant invention.

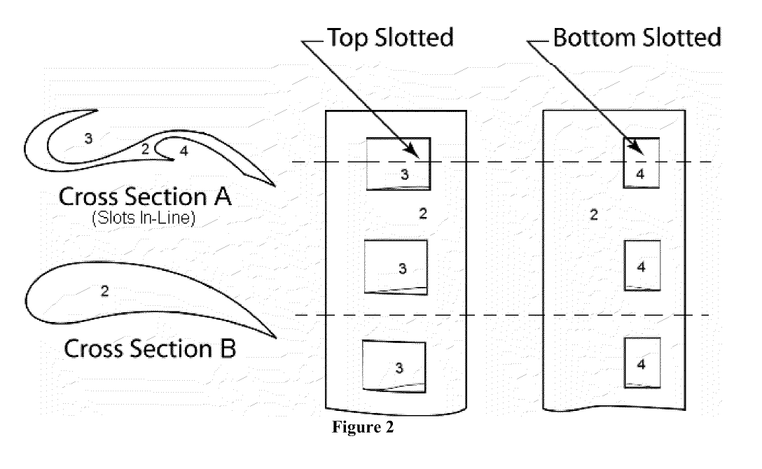

Referring to FIG. 2, another embodiment of an airfoil of the instant invention is shown. In FIG. 2, the top slots (3) and the bottom slots (4) are aligned with each other along the length of the airfoil (2). Cross Section (B) shows the wing-shape of the airfoil (2). Cross Section (A) shows the top slot (3) and bottom slot (4) aligned.

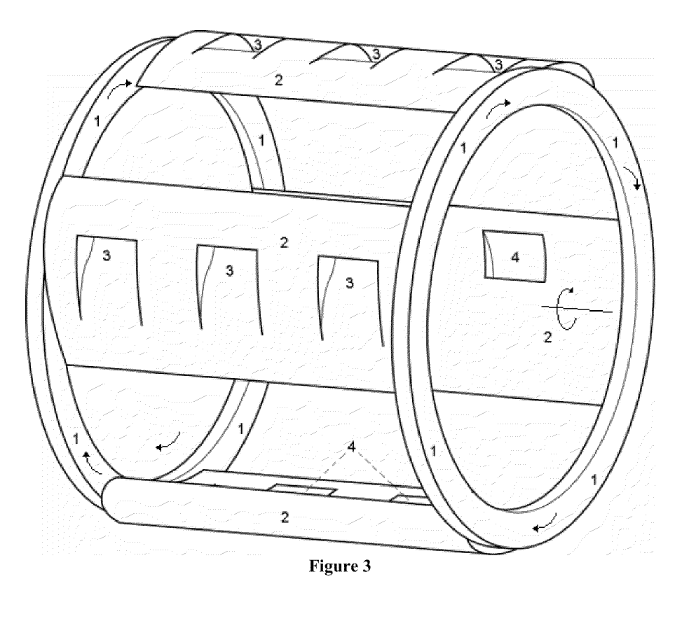

FIGS. 3 through 5 show several embodiments of systems in which the airfoils of the instant invention may be utilized to convert wind energy to rotational momentum of the system. In the systems shown in FIGS. 3 through 5, at least one airfoil is attached to a rotatable frame of the system such that the airfoil will rotate with and cause rotation of the system. As can be seen in FIGS. 3 through 5, the leading edge of the airfoil will be oriented generally in a first direction through half of the rotation of the system, and then in a second direction generally opposite of the first direction through the other half of the rotation. Thus, wind blowing in either the first or second directions will have an effect on the airfoil through half of the rotation of the system. The conversion of wind energy to rotational momentum is accomplished differently at different wind speeds and rotational velocities. At low wind speeds and low (e.g., zero) rotational velocities, the “lift” force created by the wing-shaped airfoil is less efficient and may not be adequate to self-start (or maintain) rotational motion of the system. At low wind speeds and low rotational velocities, the “drag” force created by the cup-shaped indentations is more efficient and is sufficient to self-start (and maintain) rotational motion of the system.

As described above, however, the “drag” force created by the cup-shaped indentations has substantial limitations. At higher wind speeds and higher rotational velocities, the “drag” force created by the cup-shaped indentations eventually reaches a maximum rotational velocity. At higher wind speeds and higher rotational velocities, the “lift” force created by the wing-shaped airfoil becomes more efficient than the “drag” force created by the cup-shaped indentations. At higher wind speeds and higher rotational velocities, the “lift” force created by the wing-shaped airfoil takes over the conversion of wind energy to rotational momentum of the system.

Referring to FIG. 3, an embodiment of a system for converting energy from fluid motion into rotational motion is shown. The system of FIG. 3 is comprised of two ring frames (1) and four airfoils (2) arranged generally in the shape of a cylinder. The four airfoils (2) are equally spaced from one another. Each airfoil (2) is capable of generating lift at higher wind speeds. The system of FIG. 3 rotates about an axis of rotation extending through the centers of the two ring frames (1) and generally parallel to the four airfoils (2).

Each airfoil of FIG. 3 includes three top slots (3) and two bottom slots (4), similar to the airfoil shown in FIG. 1. The system as shown in FIG. 3 is merely one embodiment of a system of the instant invention. It will be appreciated that alternatives in number, size, or shape of the airfoil(s) (2), or size, shape, or number of top slots (3) or bottom slots (4), or the number, size, or shape of the ring frame(s) (1) may be utilized without departing from the spirit and scope of the instant invention.

The ring frame(s) (1) and airfoils (2) are arranged such that when wind flows in a first direction (relative to the airfoil) within a certain range of wind speeds, at any wind speed above 0 mph, energy from the wind is captured by at least one top slot (3) or bottom slot (4) of at least one of the airfoils and causes the entire system to rotate about an axis running through the center of the ring frame (1) (or centers of the ring frames, if more than one ring frame, as shown in FIG. 3). When the wind flows across the airfoil in a second direction (relative to the airfoil, e.g., opposite direction) within a second, higher, range of wind speeds, the airfoil converts energy from the wind to a lifting force and the lifting force continues to propel the system in its rotational motion. Because the airfoils rotate with the system, the airfoils will be oriented relative to both the first direction and the second direction at different points throughout the rotation. In this manner winds acting in a single direction will have an effect on each airfoil at some point during a single rotation of the system regardless of the wind speed.

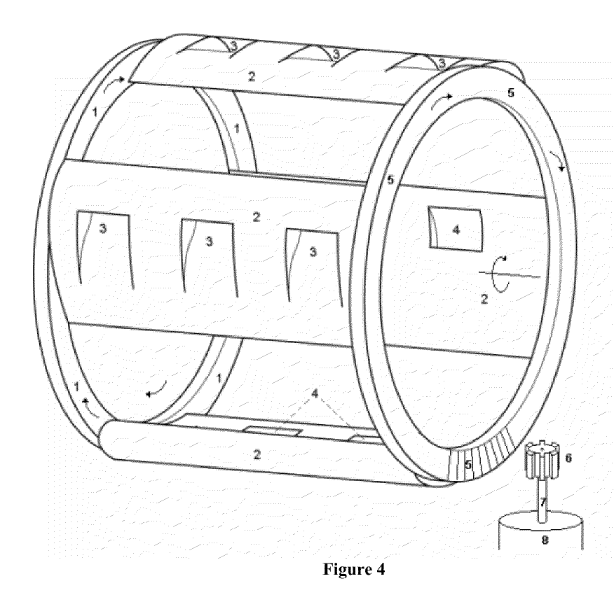

Referring to FIG. 4, another embodiment of a system of the instant invention is shown. FIG. 4 is substantially similar to FIG. 3, however, in FIG. 4 a ring gear (5) is depicted with teeth along one side of the ring gear (5). While only a few teeth are shown, along a small segment of the circle of the ring gear (5), in FIG. 4, it will be appreciated that in a preferred embodiment teeth of the ring gear (5) span the entire circle of the ring gear (5).

The four airfoils (2), ring frame (1), and ring gear (5) assembly, as found in FIG. 4, rotates about an axis running through the center of the ring frame (1) and the ring gear (5). The rotational motion is generated by the wind being caught in the top slots (3) and bottom slots (4) at lower and zero wind speeds. The rotational motion is generated by the lift generated by the wing-shaped airfoils (2) at higher wind speeds.

As the assembly rotates, the teeth of the ring gear (5) engage the teeth of a gear (6). The gear (6) is connected to, and thereby also turns a shaft (7). The shaft (7) is connected to an electrical generator (8). As the airfoils (2) convert energy from the wind into rotational motion, the ring gear (5) engages the gear (6), which turns the shaft (7), and the generator (8) converts the rotational motion into electrical power.

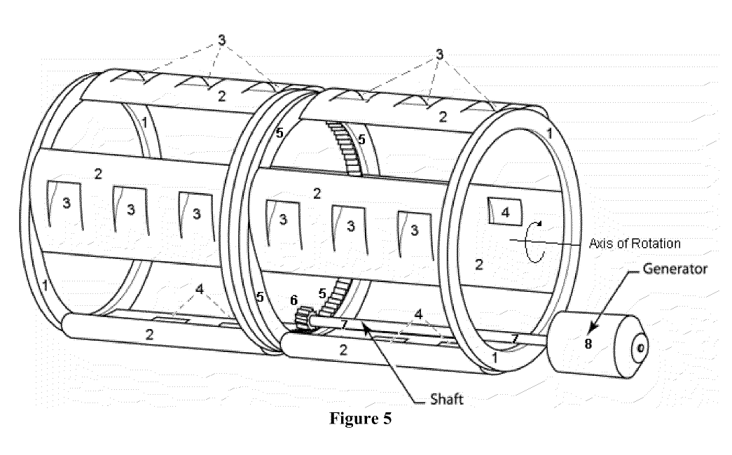

Referring to FIG. 5, another embodiment of a system of the instant invention is shown. FIG. 5 is substantially similar to FIG. 4, however, FIG. 5 shows two ring frames (1) with a ring gear (5) in the middle. An axis of rotation extends through the centers of the ring frames (1) and ring gear (5). Four airfoils (2) are arranged between the first ring frame (1) and the ring gear (5), equally spaced. Four additional airfoils (2) are arranged between the second ring frame (1) and the ring gear (5), equally spaced. All are generally arranged in the shape of a cylinder. In FIG. 5, the ring gear (5) is depicted with teeth along the interior of the ring gear (5) and the locations of the gear (6), shaft (7), and generator (8) are slightly different from FIG. 4. FIGS. 4 and 5 are examples of systems of the instant invention and do not limit its configuration or assembly. One skilled in the art can recognize that a system comprising these elements can be arranged in a multitude of configurations and still fall within the intended scope of the claims.

In the foregoing description, certain terms have been used for brevity, clearness and understanding; but no unnecessary limitations are to be implied therefrom beyond the requirements of the prior art, because such terms are used for descriptive purposes and are intended to be broadly construed. Moreover, the description and illustration of the inventions is by way of example, and the scope of the inventions is not limited to the exact details shown or described.

Although the foregoing detailed description of the present invention has been described by reference to an exemplary embodiment, and the best mode contemplated for carrying out the present invention has been shown and described, it will be understood that certain changes, modification or variations may be made in embodying the above invention, and in the construction thereof, other than those specifically set forth herein, may be achieved by those skilled in the art without departing from the spirit and scope of the invention, and that such changes, modification or variations are to be considered as being within the overall scope of the present invention. Therefore, it is contemplated to cover the present invention and any and all changes, modifications, variations, or equivalents that fall with in the true spirit and scope of the underlying principles disclosed and claimed herein. Consequently, the scope of the present invention is intended to be limited only by the attached claims, all matter contained in the above description and shown in the accompanying drawings shall be interpreted as illustrative and not in a limiting sense.

Having now described the features, discoveries and principles of the invention, the manner in which the invention is constructed and used, the characteristics of the construction, and advantageous, new and useful results obtained; the new and useful structures, devices, elements, arrangements, parts and combinations, are set forth in the appended claims.

It is also to be understood that the following claims are intended to cover all of the generic and specific features of the invention herein described, and all statements of the scope of the invention which, as a matter of language, might be said to fall therebetween.

What is claimed is:

1. An airfoil comprising:
a body capable of producing lift when a fluid flows across said body in a first direction;
wherein said body includes a top surface and a bottom surface and at least one of said top or said bottom surfaces includes a cup-shaped indentation;
wherein said cup-shaped indentation catches the fluid, generating momentum, when the fluid flows in a second direction differing from said first direction.

2. The airfoil of claim 1, wherein the fluid is air or wind.

3. The airfoil of claim 1, wherein the second fluid flow direction is generally opposite that of the first fluid flow direction.

4. The airfoil of claim 1, wherein the airfoil includes at least one indentation on both the top and the bottom.

5. The airfoil of claim 4, wherein said at least one indentation on the top is in line with the at least one indentation on the bottom.

6. The airfoil of claim 4, wherein the at least one indentation on the top is out of phase with the at least one indentation on the bottom.

7. A system for converting energy from fluid motion into rotational motion, the system comprising:
at least one airfoil capable of generating lift from a fluid motion; and
a ring frame connected to one end of said at least one airfoil, such that said at least one airfoil and ring frame rotate about an axis of rotation that extends through a center of said ring frame.

8. The system of claim 7, further comprising:
a ring gear connected to an opposing end of said at least one airfoil, such that said at least one airfoil, ring gear, and ring frame all rotate about said axis of rotation.

9. The system of claim 7, wherein said axis of rotation is generally parallel to a line extending from said one end to an opposing end of said at least one airfoil.

10. The system of claim 8, wherein the system further comprises:
a gear operably connected to said ring gear; and
a shaft connecting said gear to a generator.

11. The system of claim 7, wherein said at least one airfoil comprises:
a body capable of producing lift when a fluid flows across said body in a first direction;
wherein said body includes a top surface and a bottom surface and at least one of said top or said bottom surfaces includes a cup-shaped indentation;
wherein said cup-shaped indentation catches the fluid, generating momentum, when the fluid flows in a second direction differing from said first direction.

12. The system of claim 7, wherein the airfoil includes at least one indentation on both the top and the bottom

13. The system of claim 7, wherein the system is rotatably mounted between two floors of a building.

14. The system of claim 7, wherein the system is rotatably mounted between two buildings.

15. The system of claim 8, wherein one or both of the ring gear and ring frame are rotatably mounted between two floors of a building.

16. The system of claim 8, wherein one or both of the ring gear and ring frame are rotatably mounted between two buildings.

17. The system of claim 8, wherein said at least one airfoil comprises at least two airfoils generally evenly spaced about said ring frame and said ring gear.

18. The system of claim 8, wherein said at least one airfoil comprises at least four airfoils generally evenly spaced about said ring frame and said ring gear

19. A method for generating power, the method comprising the steps of:
connecting at least one airfoil capable of generating lift from a fluid motion to a ring gear; and
allowing rotation of said at least one airfoil and said ring gear about an axis of rotation that extends through a center of said ring gear; and
rotating a gear associated with said ring gear, said gear being operably connected to a generator.

20. The method of claim 19, wherein said gear is operably connected to said generator via a shaft.

21. The method of claim 19, wherein the at least one airfoil comprises:
a body capable of producing lift when a fluid flows across said body in a first direction;
wherein said body includes a top surface and a bottom surface and at least one of said top or said bottom surfaces includes a cup-shaped indentation;
wherein said cup-shaped indentation catches the fluid, generating momentum, when the fluid flows in a second direction differing from said first direction.].

22. The method of claim 21, wherein the airfoil includes at least one indentation on both the top and the bottom.

23. The method of claim 19, further comprising the step of converting rotational motion of said at least one airfoil to electrical power via the generator.

24. The method of claim 19, further comprising:
connecting a distal end of said airfoil to a ring frame such that the shape of said at least one airfoil, ring gear and ring frame is generally cylindrical.

25. A system for converting energy from fluid motion into rotational motion, the system comprising:
a first system for converting energy from fluid motion into rotational motion, said first system comprising: (a) at least one airfoil capable of generating lift from a fluid motion, (b) a ring frame connected to one end of said at least one airfoil, such that said at least one airfoil and ring frame rotate about an axis of rotation that extends through a center of said ring frame, and (c) a ring gear connected to an opposing end of said at least one airfoil, such that said at least one airfoil, ring gear, and ring frame all rotate about said axis of rotation; wherein said first system rotates in a first direction, and
a second system for converting energy from fluid motion into rotational motion, said second system comprising: (a) at least one airfoil capable of generating lift from a fluid motion, (b) a ring frame connected to one end of said at least one airfoil, such that said at least one airfoil and ring frame rotate about an axis of rotation that extends through a center of said ring frame, and (c) a ring gear connected to an opposing end of said at least one airfoil, such that said at least one airfoil, ring gear, and ring frame all rotate about said axis of rotation; wherein said second system rotates in a second direction.

26. The system of claim 25, wherein the axis of rotation of said first system is parallel to the axis of rotation of said second system.

27. The system of claim 25, wherein the axis of rotation of said first system is aligned with the axis of rotation of said second system.

28. The system of claim 25, wherein said first system and said second system are connected to a generator.
